(19) United States
(12) Patent Application Publication
(10) Pub. No.: US 2011/0264719 A1
(43) Pub. Date: Oct. 27, 2011

(54) HIGH RADIX DIGITAL MULTIPLIER

(75) Inventor: Mikael Mortensen, Lyngby (DK)

(73) Assignee: AUDIOASICS A/S, Allerod (DK)

(21) Appl. No.: 13/126,328

(22) PCT Filed: Sep. 23, 2009
(86) PCT No.: PCT/EP2009/062295

§ 371 Date: Jul. 11, 2011

Related U.S. Application Data
(60) Provisional application No. 61/109,650, filed on Oct. 30, 2008.

(51) Int. Cl. G06F 7/491

(52) U.S. Cl. 708/204; 708/523; 708/523

(57) ABSTRACT

The present invention relates to power and hardware efficient digital multipliers configured to multiply an N-bit multiplicand with an M-bit multiplier. The digital multipliers comprise efficient partial product generation through sharing of at least one partial product result.

The present invention relates to power and hardware efficient digital multipliers configured to multiply an N-bit multiplicand with an M-bit multiplier. The digital multipliers comprise efficient partial product generation through sharing of at least one partial product result.

### BACKGROUND OF THE INVENTION

Digital multipliers are used to multiply binary numbers and form essential components in a wide range of today's computing products such as general purpose microprocessors, digital signal processors, graphic engines and various computational units of Application Specific Integrated Circuits (ASICs).

Digital multipliers are generally adapted to rapidly multiply a first binary number, a N-bit multiplicand (Y), with a second binary number, a M-bit multiplier (X), where each of these binary numbers can be represented in various binary number formats such as two's complement or signed magnitude. The number of bits used to represent each of the N-bit multiplicand (Y), i.e. N, and the M-bit multiplier (X), i.e. M, can vary widely depending on specific requirements of any particular application. In digital signal processors designed for digital audio applications, it has been common practice to represent each of N and M with 16 bits to form a 16×16-bit digital multiplier. However, digital multipliers with larger values of N and M, for example 24 bits representation of M and N, have also been on the market aiming at improving accuracy of variables and constants of Digital Signal Processing (DSP) algorithms.

An M times N-bit multiplication (M*N) can be viewed as a process of forming N partial products of M bits each and subsequently summing appropriately shifted versions of the N partial products to produce an M+N-bit result, P. If the partial products are organized in rows below each other, the multiplication result P can be calculated by adding all binary numbers down each of the columns and pass any carry value to the next column. It is clear that the number of individual cells and complexity of the digital multiplier grows rapidly with growing values of M or N. There exists a number of prior art approaches to combat this growth of complexity and reduce the number of partial products that must be summed/processed in a digital multiplier. A known approach is to compute the partial products in a radix 2^{r} manner, where the number r is a positive integer. Radix 2^{r} multipliers produce only N/r partial products each of which depends on a set of r bits of the M-bit multiplier (X). Fewer partial products lead to a smaller and faster array of carry-save adders that are frequently utilized to add the plurality of partial products into a multiplication sum.

A radix-4 multiplier produces N/2 partial products while a radix-8 multiplier produces N/3 partial products. A well-recognized disadvantage of ordinary radix-4 multipliers is that they require a computation or calculation of a set of partial product results that includes a 3 times Y (3Y) result in addition to partial product results of 0, Y, 2Y—where Y as previously-mentioned represents a value of the N-bit multiplicand. While partial product results 0, Y, 2Y are computable in a simple manner in binary number formats, the 3Y partial product result is a so-called hard multiple of Y requiring a slow carry-propagate addition of Y +2Y. Likewise, radix-8 multipliers require computation of several hard multiple partial product results in form of 3Y, 5Y and 7Y.

Modified Booth encoding or Booth encoding is a well-established technique or coding scheme for eliminating, or at least reducing, the number of hard multiples to be computed in radix-4 and radix-8 digital multipliers. In radix-4 Booth encoding, the hard multiple 3Y is eliminated by a coding scheme that uses negative partial products. This allows the 3Y partial product result to be computed as 4Y minus Y. In the common two's complement binary number format, a negative of Y can be formed quite simply by inverting the bits of Y and adding one.

However, some challenges persist in radix-8 Booth encoded multipliers because these still require the computation of the partial product result 3Y in or order to determine or compute other hard multiples of values 5Y and 7Y. For digital multipliers that utilize even higher radix-figures such as radix-16 and radix-32, the number of hard multiplies grows so large that Booth encoding techniques have generally been avoided or discouraged see for example CMOS VLSI Design, Addison-Wesley, Third Edition 2005 by Weste et al., page 702. The calculation of many hard multiples of the N-bit multiplicand (Y) has been considered to require an additional unjustifiable large amount of complex logic and arithmetic circuitry in each of the partial product generators. Adding large amounts of complex logic and arithmetic circuitry to the partial product generators imply large area consumption on a semiconductor die or substrate on which the digital multiplier is integrated. Likewise, the addition of complex logic and arithmetic circuitry imply slower operation, for example longer multiplication cycles, and a significant increase in physical layout complexity on the semiconductor substrate.

The complexity of known coding schemes and associated logic and arithmetic circuitry of partial product generators therefore present significant obstacles to successful exploitation of high radix digital multipliers for the above-mentioned reasons. This problem is pronounced for digital multipliers that are targeted for low-power, and preferably also low cost, digital signal processing applications. The complexity of the known coding schemes and associated logic and arithmetic circuitry tend to increase power consumption and semiconductor substrate area occupation of the digital multiplier in an undesirable manner.

This problem and others have been solved in accordance with one aspect of the present invention where a digital multiplier comprises a plurality of partial product generators with uniform coding scheme and two or more of the plurality partial product generators are adapted to share at least one partial product result. The at least one partial product result may in a particularly advantageous embodiment comprise one or more hard multiple(s) of the N-bit multiplicand (Y).

### PRIOR ART

U.S. Pat. No. 5,835,393 discloses a combined pre-adder/Booth encoder for digital multiplier. The inclusion of the pre-adder in front of the Booth encoder is an improvement over traditional multiply accumulate units (MACs) because the pre-adder allows certain DSP algorithms to be executed in fewer clock cycles. The disclosed multiplier structure utilizes a conventional radix-4 Booth encoding scheme and associated logic.

A paper titled “A Hybrid Radix-4/Radix-8 Low Power, High Speed Multiplier Architecture for Wide Bit Widths”, by Brian S. Cherkauer and Eby G. Friedmann, IEEE transactions on circuits and systems. 2, Analog and digital signal processing, 1997, vol. 44, no 8, pp. 656-659 discloses two hybrid multiplier architectures for multiplying 32×32 and 64×64 bit numbers, respectively, in two's complement format. The hybrid multiplier architecture comprises two parallel arrays of partial product generators wherein one partial product array uses radix-4 Booth encoding while the second partial product array uses radix-8 Booth encoding. A computation of 3 times the multiplicand in the second partial product array (radix-8) is performed simultaneously with a reduction of radix-4 partial products of the first partial product array.

### SUMMARY OF INVENTION

In accordance with a first aspect of the invention, a digital multiplier is configured to multiply an N-bit multiplicand with an M-bit multiplier. The digital multiplier comprises a first number format converter configured to receive the N-bit multiplicand in a first binary number format and convert the N-bit multiplicand into a second binary number format. A plurality of partial product generators is adapted to select respective partial products of the N-bit multiplicand. Each partial product is selected from a set of partial product results computed or derived from the N-bit multiplicand in the second binary number format in dependence of a predetermined set of bits of the M-bit multiplier in accordance with a predetermined coding scheme. An adder structure is configured to receive and combine a plurality of partial products to produce an intermediate multiplication result and a second number format converter is arranged to receive the intermediate multiplication result and convert the intermediate multiplication result into a P-bit multiplication result in the first binary number format. Two or more partial product generators are adapted or configured to share at least one partial product result; Each of P, M and N representing a positive integer number such as an integer between 16 and 64.

In the present specification and claims, the term “hard multiple” designates a multiple of the N-bit multiplicand which can not be generated by anyone of the below-mentioned sets of logic operations for each of the following binary number formats:

Two's complement: {left shifting, right shifting, negating};

Signed magnitude: {left shifting, right shifting, negating};

Carry save: {left shifting, right shifting, negating};

Redundant binary signed digit: {left shifting, right shifting, negating, subtracting}.

A first memory element may be used to temporary or intermediately hold or store the N-bit multiplicand and a second memory element may be used to intermediately hold or store the M-bit multiplier during a multiplication cycle or operation. Each of the first and second memory elements may comprise temporary or volatile memory means such as register files, latches, RAM cells etc or any combination thereof.

The digital multiplier may be adapted to accept various commonly used binary number formats as the first binary number format such as binary number format selected from a group of {two's complement, signed magnitude, carry save} to allow the present digital multiplier to seamlessly interface to other digital computational hardware using one of these common binary number formats. The first binary number format is preferably two's complement which is the most widely used binary number format in Digital Signal Processors (DSPs). The widespread use of two's complement is probably for historic reasons and due to certain advantages related to subtraction of two's complement numbers and overflow/underflow safeguarding Finite Impulse Response (FIR) filter computations. The first binary number format is preferably another format than the redundant binary signed digit (RBSD) format which is the preferred format as the second binary number format.

The first and second number format converters are operative to perform conversions forth and back between the first and second binary number formats. The presence of the first and second number format converters is advantageous in that the plurality of partial products may be computed in a second number format that is highly efficient in terms of hardware resources and computational burden for example in computing hard multiplies of the N-bit multiplicand. Accordingly, the hardware resource and computational effort expenditure imposed on the digital multiplier by the first and second number format converters is readily offset by the ability to reduce the number of hard multiplies that must be computed in higher radix coding schemes such as radix-16 or higher Booth coding. This is explained in detail in connection with the description of FIGS. 9 & 10 below of an exemplary 24*24 bits radix-16 Booth encoded digital multiplier and its associated RBSD based partial product generator. At the same time the present digital multiplier retains interoperability to, or compatibility with, existing surrounding logic and arithmetic circuitry utilizing the first number format for binary number computations.

In the particular RBSD based 24*24 bits radix-16 Booth encoded digital multiplier described on FIGS. 9 & 10 below, only a single hard multiple such as 3*N-bit multiplicand needs to be computed in the RBSD format. The residual hard multiplies 7Y, 6Y and 5Y in two's complement number format can be derived from the 3Y hard multiple in a computationally/hardware efficient manner in the RBSD format.

In one preferred embodiment of the invention, the first binary number format is two's complement and the second binary number format is redundant binary signed digit.

In accordance with the present invention, two or more partial product generators are adapted to share at least one partial product result. Sharing the at least one partial product result between two or more partial product generators leads to a significant reduction in an amount of combinational logic and/or arithmetic circuitry required to compute partial product results in the digital multiplier. Furthermore, the sharing of the at least one partial product result additionally leads to a significant reduction in power consumption of the digital multiplier because the number of parallel computations of the at least one partial product result is reduced. These advantages are of course particularly pronounced if the at least one partial product is shared by a majority of the plurality of partial product generators such as more than 60%, or preferably more than 70%, or even more preferably more than 90%, and most preferably all of the plurality of partial product generators, of the digital multiplier. In the latter embodiment, just a single computation of the at least one partial product result needs to be performed. This embodiment leads to a significant decrease in the amount of combinational logic and/or arithmetic circuitry required to compute the at least one partial product result and the advantages grow both with increasing values of M and N and with increasing radix figures of the predetermined coding scheme.

In a number of embodiments of the invention, which are particularly well-suited for low-power digital signal processors for mobile terminals, N is smaller than 31, and/or M is smaller than 31 to keep power consumption and size of the digital multiplier reasonably low. In certain other embodiments of the invention, both of M and N are 16, 24 or 32 to form 16*16-bit, 24*24-bit and 32*32-bit digital multipliers, respectively. However, while M and N are both positive integer numbers, they can have different values in other embodiments of the invention. In some useful embodiments of the invention (M, N) are (8,16), (12,16) or (16,32) which may match requirements of certain DSP algorithms such as filters or transforms where filter or transform coefficients can be represented in a lower resolution than incoming data. In other DSP algorithms for example in connection with oversampled digital audio systems filter coefficients may have higher resolution than incoming audio samples or data. In decimation systems, incoming data may be represented by 2-5 bits audio samples while coefficients of decimation filters may have a length between 16 and 32 bits. The adder structure or tree may comprise a plurality of individual adders depending on actual values of M and N. The plurality of individual adders may comprise different types of adder and adder arrays known in the art such as a mix of carry-save adders and/or carry-propagate adders that may be structured into respective regular arrays to obtain a compact circuit layout. The adders may be structured as a Wallace tree to reduce the number of adders and delays through the adder structure.

The predetermined coding scheme determines how the predetermined set of bits of the M-bit multiplier (“X”) is to be selected and decoded to compute the partial product results from the N-bit multiplicand (“Y”). Several coding schemes exist wherein direct array encoding and Booth encoding probably are the most widely known. In direct array radix-4 coding a set of two bits of X (M-bit multiplier) is utilized in each partial product generator to select or compute the partial product from a set of partial products results that comprises (0, Y, 2Y, 3Y). The plurality of partial product generators uses successive set of bits of X to generate the respective partial products so that the direct array radix-4 coding of a 16-bit N value uses a total of 8 successive sets of bits of 2 bits each. The radix-4 coding allows a reduction from N to N/2 in the number of generated partial products. Likewise, direct array radix-8 coding uses bit sets of 3 bits of X to compute partial products from a set of partial product results that comprises (8Y,7Y, 6Y, 5Y, 4Y, 3Y, 2Y, Y, 0) and negative counterparts.

Booth encoding is another coding scheme and can be viewed as a methodology for converting the hard multiples of Y, such as 3Y, 5Y, 6Y and 7Y in the above-mentioned examples, into simpler partial product results by relying on negative values of the partial products. For example, the hard multiple 3Y may be calculated as 4Y-Y and 6Y as 2*3Y etc. Table 1 and Table 2 demonstrate how Booth encoding of a radix-4 and a radix-8 digital multiplier works.

However, the advantages of the present invention are equally applicable for all types predetermined coding schemes. Since the coding schemes generally aim at converting certain hard multiples of Y into partial products results that are determinable with less computational effort, improvements provided by the present invention in sharing the at least one partial product result across multiple partial product generators remain in full effect after an initial reduction of the number of hard multiples.

As mentioned above, of digital multipliers in accordance with the present invention are smaller in terms of semiconductor substrate area than prior art digital multipliers. This leads to lower manufacturing costs of integrated semiconductor circuits comprising the present digital multipliers. In addition, power consumption of the digital multiplier is also reduced because a large number of parallel and independent computations of the at least one partial product result in prior art digital multipliers have been reduced to fewer, or even a single computation, of the at least one partial product result during a multiplication cycle. The savings in terms of semiconductor substrate or die area and power consumption of the present digital multiplier are of course particularly pronounced in embodiments where the at least one partial product result comprises one or more hard multiples of Y (N-bit multiplicand) in the second binary number format. This is because computation of hard multiplies needed in higher radix digital multipliers in most binary number systems requires a significant portion of complex combinational logic and/or arithmetic circuitry with associated power consumption and usage of semiconductor substrate area.

If the second binary number format is two's complement, the at least one partial product result may accordingly comprise one or more of 3Y, 5Y, 6Y and 7Y etc.

In a particularly advantageous embodiment of the invention, only a single partial product generator, of the plurality of partial product generators, computes the at least one partial product result. Consequently, in an exemplary radix-8 Booth encoded 24×24-bit digital multiplier, the number of independent computations of the at least one partial product result per multiplication cycle can be reduced from 8 (one partial product computation in each partial product row) to just one.

According to one embodiment of the invention, the at least one partial product result and the plurality of partial products are computed sequentially for example in a first and a second clock phase of a multiplication cycle, respectively, where the at least one partial product result is computed in the first and clock phase and the plurality of partial products are computed in the second clock phase. The sequential order of computation ensures that the at least one partial product result has a reached a stable value before the computation of the plurality of partial products is started.

In a particularly advantageous embodiment of the invention, a non-hybrid or uniform predetermined coding scheme is utilized by substantially all of the plurality of partial product generators. In this context “substantially all” means that more than 60%, or preferably more than 70%, or even more preferably more than 90%, and most preferably all of the plurality of partial product generators utilize the uniform predetermined coding scheme. Utilizing a uniform predetermined coding scheme, for example Booth encoding, leads to a particularly regular and compact digital multiplier circuit layout because all partial product generators have essentially identical dimensions and form factors. The latter property allows the plurality of partial product generators to be placed in close proximity or abutment with each other so as to occupy a minimum of semiconductor substrate area and a minimum of interconnecting electrical traces. Furthermore, the uniform predetermined coding scheme combines with the sharing of the least one partial product result between two or more partial product generators in an advantageous manner by further reducing power consumption and consumption of semiconductor substrate area, in particular in embodiments where the shared partial product result or results are generated by a single externally (relative to the partial product generators) arranged arithmetic unit.

In one embodiment of the invention, the least one partial product result is computed by the above-mentioned arithmetic unit. The arithmetic unit may comprise combinational logic and/or arithmetic circuitry such as adder(s), for example a full-adder or carry propagate adder, and a shift register. In one embodiment, the arithmetic unit is arranged inside a single one of the partial product generators and the least one partial product result computed by the arithmetic unit distributed by appropriate data wires or busses to those partial product generators that lack necessary arithmetic circuitry to independently compute the least one partial product result.

In another embodiment of the invention, the arithmetic unit is arranged outside the plurality of partial product generators and the least one partial product result transmitted into the two or more partial product generators adapted to share at least one partial product result. In this case, the arithmetic unit may be arranged outside a circumferential border of a multiplier layout structure. An appropriately routed data bus or busses are preferably routed across the multiplier layout so as to convey the at least one partial product result from the arithmetic unit into each of the partial product generators. According to this embodiment, each of the plurality of partial product generators preferably lacks the necessary arithmetic unit to perform a local computation of the least one partial product result. A significant advantage of the embodiment is that complex arithmetic and logic circuitry, required to compute for example one or several hard multiples of Y in higher radix digital multipliers, is absent in each of the partial product generators. This will lead to a smaller and more regular cell structure of partial product generator rows in a multiplier circuit layout. Higher regularity leads in turn to smaller size of the multiplier circuit layout and potentially to lower power consumption because of reduced parasitic capacitances.

The predetermined coding scheme preferably comprises a Booth coding scheme selected from a group of {radix-16, radix-32, radix-64, radix-128} Booth coding. The advantages of the present invention generally increase with increasing radix figure because the advantages associated with sharing the at least one partial product result between two or more partial product generators, tend to increase with a growing number of hard multiples. As an example, a radix-16 Booth encoded digital multiplier requires computation of the following partial product results: 8Y, 7Y, 6Y, 5Y, 4Y, 3Y, 2Y, Y, 0 and their negative counterparts. The hard multiples in two's complement format are: 7Y, 6Y, 5Y and 3Y while the negative counterparts of these are computationally simple in two's complement representation as explained previously. 3Y may be selected as the at least one partial product result but this still leaves 7Y and/or 5Y to be computed (because 6Y is derived from 3Y by a simple left shift operation). Consequently, the at least one partial product result may advantageously comprise 5Y and/or 7Y as well so as to relieve two or more, and preferably all, of the plurality of partial product generators from computing these hard multiples locally. Instead, 3Y, 5Y and/or 7Y may be computed by the arithmetic unit and transmitted to the plurality of partial product generators. This leads to even more pronounced savings in terms of die area occupation and power consumption.

According to a second aspect of the invention, a semiconductor substrate comprises a digital multiplier according to any of the above-described digital multiplier embodiments integrated on the semiconductor substrate. The digital multiplier has a substantially rectangular layout enclosed behind a circumferential border on a surface of the semiconductor substrate. The plurality of partial product generators are arranged in a partial product array close to the circumferential border and the arithmetic unit arranged adjacent to the circumferential border but outside of the partial product array. The latter means that the arithmetic unit is placed outside a circumferential line intersecting the outer border of the partial product array. Data busses extend across the partial product array and convey the at least one shared partial product result into the two or more partial product generators.

According to a third aspect of the invention, there is provided a digital multiplier for multiplying binary numbers. The digital multiplier comprising a first memory element for storing a N-bit multiplicand and a second memory element for storing a M-bit multiplier. A plurality of partial product generators adapted to select respective partial products of the N-bit multiplicand. Each partial product is selected from a set of partial product results computed from the N-bit multiplicand in dependence of a predetermined set of bits of the M-bit multiplier in accordance with a predetermined coding scheme. An adder structure is configured to receive and combine a plurality of partial products to produce a P-bit multiplication result. Two or more partial product generators are adapted to share at least one partial product result which comprises a hard multiple of the N-bit multiplicand. The plurality of partial product generators utilizes a uniform predetermined coding scheme; Each of P, M and N being a positive integer number.

The advantages of sharing the at least one partial product result between two or more partial product generators, and preferably between all of the plurality of partial product generators. as described above in connection with the first aspect of invention are equally applicable to the present digital multiplier. The uniform predetermined coding scheme applied to the partial product generators, for example Booth encoding, leads to a particularly regular and compact digital multiplier circuit layout with a minimum signal routing because all partial product generators can be made with essentially identical dimensions and form factors.

### BRIEF DESCRIPTION OF THE DRAWINGS

A preferred embodiment of the invention will be described in more detail in connection with the append drawings in which:

FIG. 1a is a schematic drawing of a prior art partial product generator based on radix-4 Booth encoding,

FIG. 1b is a schematic drawing of a prior art partial product generator based on radix-8 Booth encoding,

FIG. 2 is a schematic drawing of prior art 16×16 bit radix-4 Booth encoded digital multiplier comprising a plurality of partial product generators in accordance with FIG. 1b,

FIG. 3 is a schematic drawing of a partial product generator based on radix-8 Booth encoding suitable for use in digital multipliers according to the present invention,

FIG. 4 is a schematic drawing of a 24×24 bit radix-8 Booth encoded digital multiplier with an arithmetic unit in accordance with a first embodiment of the present invention,

FIG. 5 is an alternative schematic drawing of the 24×24 bit radix-8 Booth encoded digital multiplier depicted on FIG. 4,

FIG. 6 is a schematic circuit layout or floor-plan of the 24×24 bit radix-8 Booth encoded digital multiplier depicted on FIGS. 4 & 5,

FIG. 7 is a schematic drawing of a 24×24 bit radix-8 Booth encoded digital multiplier comprising first and second number format converters according to a second embodiment the present invention,

FIG. 8 is a detailed schematic diagram of an arithmetic unit employed in the 24×24 bit radix-8 Booth encoded digital multiplier depicted in FIG. 7,

FIG. 9 is a schematic drawing of a 24×24 bit radix-16 Booth encoded digital multiplier comprising first and second number format converters according to a third embodiment of the present invention; and

FIG. 10 is a schematic drawing of a partial product generator for the digital multiplier depicted in FIG. 9 and based on radix-16 Booth encoding with partial product computation on binary numbers represented in redundant binary signed-digit format.

### DESCRIPTION OF PREFERRED EMBODIMENTS

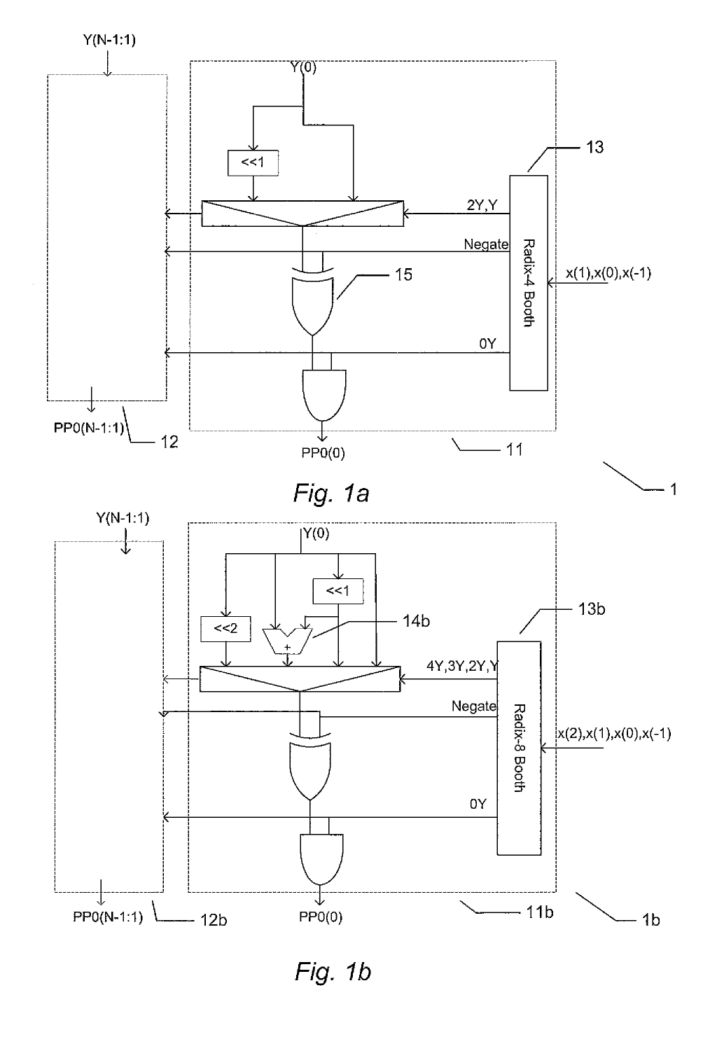

FIG. 1a shows a prior art partial product generator 1 based on radix-4 Booth encoding and operating on two's complement binary numbers. Dashed box 11 illustrates logic circuitry for computation of a single bit of a first partial product, PP0. A Booth encoding block 3 determines how a code derived from a predetermined set of bits, in this case indicated x(1),x(0), x(−1) bits, of the M-bit multiplier (“X”) is used to manipulate a first bit, Y(0) of a N-bit multiplicand (“Y”) to compute or select indicated bit value PP0(0) of the first partial product PP0. As indicated PP0(0) is selected, by the indicated select signals, 2Y, Y, Negate and 0, from a set of 5 different possible partial product results, 2Y, Y, 0, −2Y, −Y where the negative values −2Y and −Y are selected or coded by XOR gate 15 under control of the indicated Negate select line of Booth encoding block 13. Clearly, each of the 5 different partial product results, 2Y, Y, 0, −2Y, −Y can be computed by a relatively modest amount of logic circuitry by shifting and negating operations. As previously-mentioned, in radix-4 Booth encoding the computation of a hard multiple 3Y has been replaced with simpler logic operations.

As indicated by adjacent dashed boxes 11 and 12, the partial product generator 1 comprises a total of N sections of illustrated partial product bit computation circuitry inside dashed box 11 wherein the N-1 residual sections computes respective bits, PP0(N-1), PP0(N-2) etc of the N-bit long partial product result, PP0.

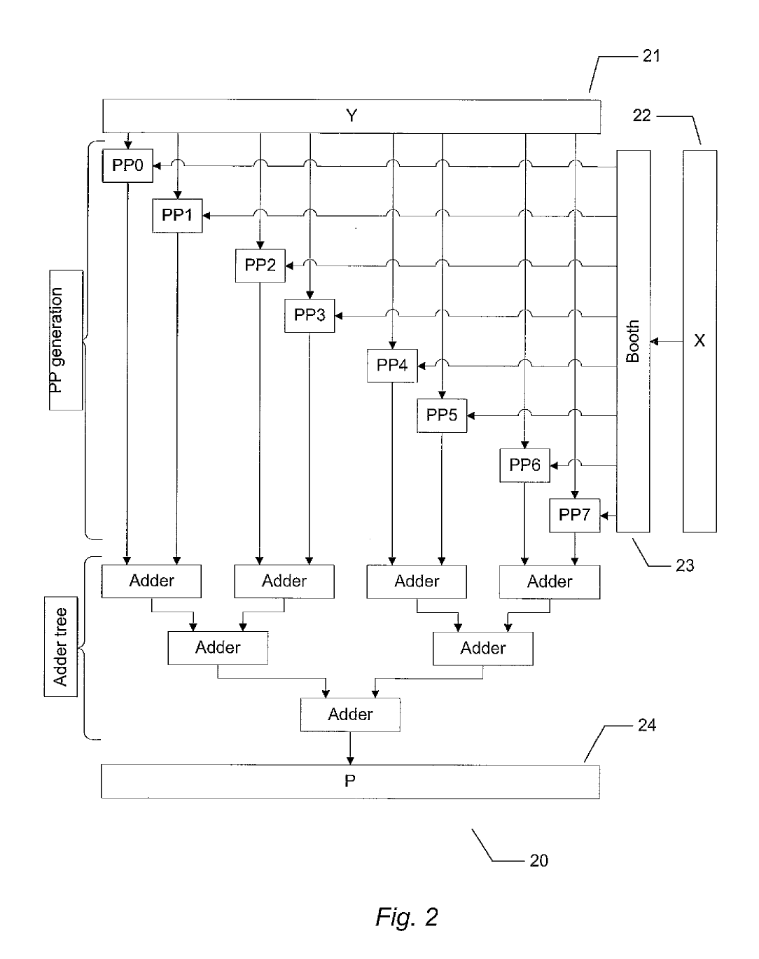

A subsequent partial product generator, for example PP1 (indicated on FIG. 2), may use a subsequent set of bits of the M-bit multiplier x(3),x(2), x(1), to generate a second partial product and so on for all partial product generators required by a particular digital multiplier architecture. The total number of partial product generators in a digital multiplier depends in general on the number of bits of the N-bit multiplicand, a chosen radix-figure of the encoding scheme and the encoding scheme itself.

Table 1 below shows the output, PP0, of the first partial product generator 1 as function of Y in dependence of the predetermined set of bits of the M-bit multiplier.

TABLE 1
Radix-4 Booth encoding

| Inputs(bits of | | | |
|---|---|---|---|
| M-bit multiplier) | | | Partial product |
| x(1) | x(0) | x(−1) | PP0ᵢ |
| 0 | 0 | 0 | 0 |
| 0 | 0 | 1 | Y |
| 0 | 1 | 0 | Y |
| 0 | 1 | 1 | 2Y |
| 1 | 0 | 0 | −2Y |
| 1 | 0 | 1 | −Y |
| 1 | 1 | 0 | −Y |
| 1 | 1 | 1 | 0 |

FIG. 1b is a schematic drawing of a second prior art partial product generator 1 based on radix-8 Booth encoding. Radix-8 Booth encoding implies that four predetermined bits of the M-bit multiplier (“X”) are utilized for the encoding of each partial product as indicated on the figure by the set of bits: x(2), x(1), x(0), x(−1). Since radix-8 of Booth encoding requires a computation of partial product result 3Y, i.e. a hard multiple, a full adder 14b has been added to partial product bit computation circuitry illustrated inside dashed box 11b for this purpose. Inputs to the adder are Y(0) and 2Y(0) as indicated on the figure. Other partial product results such as 4Y and 2Y are computed by respective shift registers as indicated on the drawing. As explained above, the second partial product generator 1b accordingly comprises a set of N full adders like full adder 14b to compute the N-bit partial product output PP0 of the multiplier Y. Furthermore, a complete digital multiplier comprises a plurality of partial product generators operating simultaneously and in parallel to provide the plurality of partial products.

Table 2 below shows the output, PP0, of the second prior art partial product generator 1b as function of Y in dependence of the predetermined set of bits, x(2), x(1), x(0), x(-1), of the M-bit multiplier.

TABLE 2
Radix-8 Booth encoding

| | |
|---|---|
| Inputs (bits | |
| of M-bit multiplier) | Partial product |

| x(2) | X(1) | x(0) | x(−1) | PPRᵢ |
|---|---|---|---|---|
| 0 | 0 | 0 | 0 | 0 |
| 0 | 0 | 0 | 1 | Y |
| 0 | 0 | 1 | 0 | Y |
| 0 | 0 | 1 | 1 | 2Y |
| 0 | 1 | 0 | 0 | 2Y |
| 0 | 1 | 0 | 1 | 3Y |
| 0 | 1 | 1 | 0 | 3Y |
| 0 | 1 | 1 | 1 | 4Y |
| 1 | 0 | 0 | 0 | −4Y |
| 1 | 0 | 0 | 1 | −3Y |
| 1 | 0 | 1 | 0 | −3Y |
| 1 | 0 | 1 | 1 | −2Y |
| 1 | 1 | 0 | 0 | −2Y |
| 1 | 1 | 0 | 1 | −Y |
| 1 | 1 | 1 | 0 | −Y |
| 1 | 1 | 1 | 1 | 0 |

While this prior art approach may be effective in terms of speed, it consumes considerable die area and electrical power.

FIG. 2 is a schematic drawing of prior art 16×16 bit radix-4 Booth encoded digital multiplier 20 comprising a plurality of partial product generators, PP0, PP1, PP2 etc, of the same type as those described in connection with FIG. 1a. A 16-bit multiplicand, Y, in two's complement format is temporarily stored in a first register file 21 or other suitable memory structure and the multiplicand, X, is held in a second register file 22 or other suitable memory structure. A Booth encoder 23 is operatively connected to the second register file 212 which holds a current value of X and uses successive sets of 3 bits for encoding respective select signals to the partial products generators, PP0-PP7 as previously explained in connection with FIG. 1. This prior art digital multiplier comprises a total of 8 partial product generators which equals N/2 because radix-4 coding implies that each pair of original or non-encoded partial products is reduced to one partial product. An adder structure or adder tree sums respective outputs of the N/2 partial products generators, PP0-PP7, and reduces the outputs to a single multiplication result, P, of 32 bits (M+N) held in a third register 24 of length N+M bits.

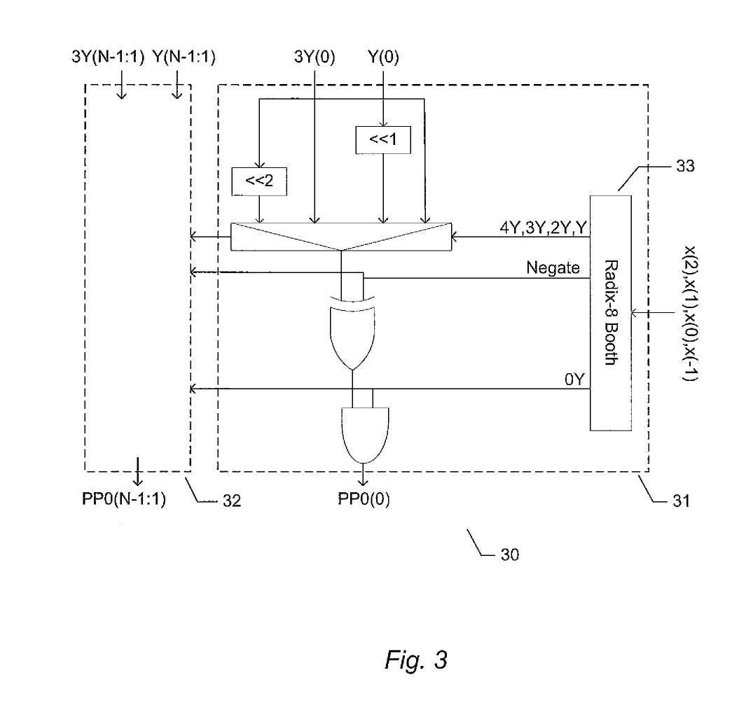

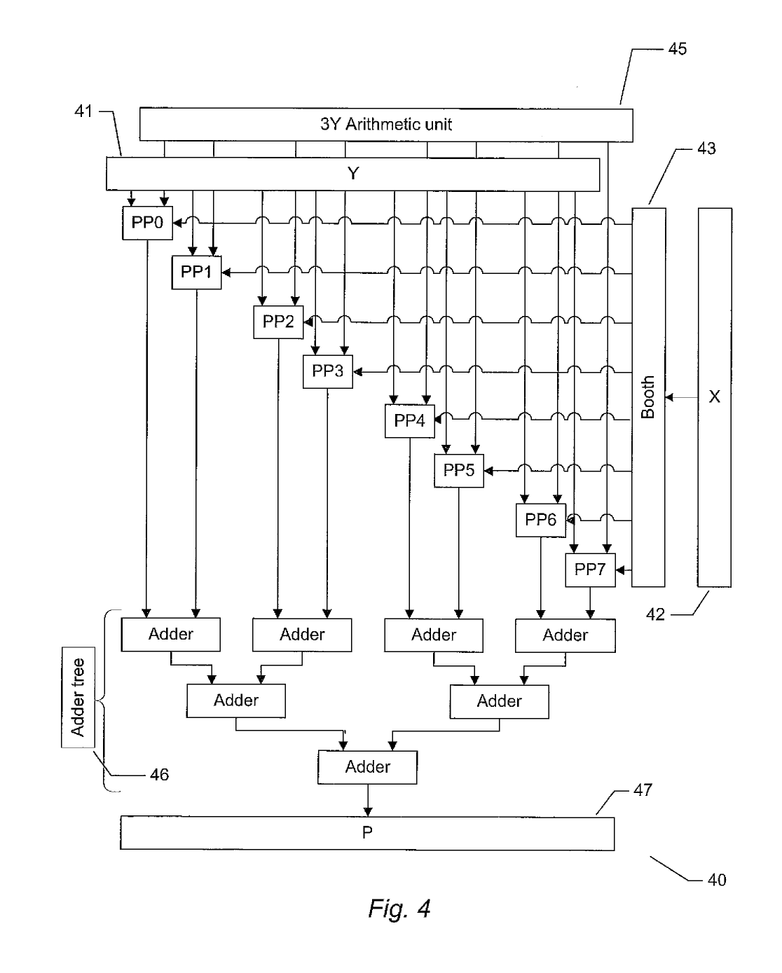

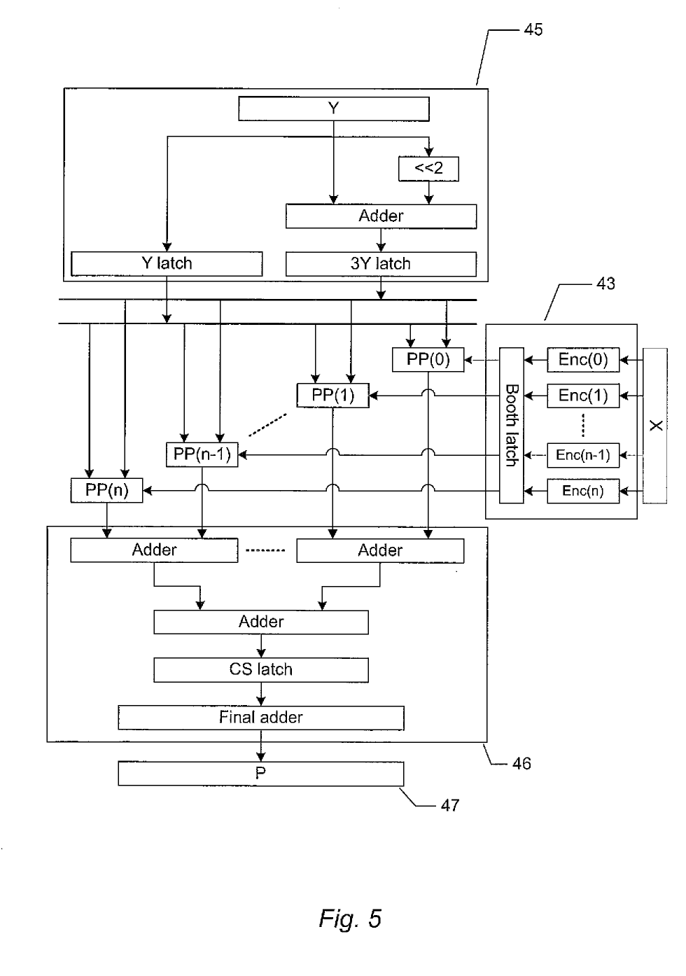

FIG. 3 shows a partial product generator 30 based on radix-8 Booth encoding suitable for use in a digital multiplier according to a preferred embodiment of the present invention. The partial product generator 30 is adapted to operate on binary numbers in two's complement format. Comparing partial product bit computation circuitry 31 inside the dashed box with the partial product bit computation circuitry 11b of the prior art radix-8 partial product generator depicted on FIG. 1b, reveals that bit(0) of partial product result 3Y, indicated as 3Y(0) is transmitted into the partial product bit computation circuitry 31 from the outside. A multiplexer 35 controlled by a select signal of Booth encoder 33 determines which one of the partial product result bits, Y(0), 2Y(0), 3Y(0) and 4Y(0) that is selected. Residual bits of 3Y, such as Y(1), Y(2), . . . Y(N-1), are also transmitted into all other respective partial product bit computation circuits 32 so that the partial product result 3Y is computed by logic circuitry entirely outside of the partial product generator 30. This is in contrast to the prior art partial product generator 1b depicted on FIG. 1b wherein a set of N parallelly operating full adders 14b are arranged inside of the partial product generator 1b. In the present embodiment of the invention, the partial product result 3Y is advantageously computed outside of the partial product generator 30 by a dedicated arithmetic unit 45 (refer to FIG. 5) which computes 3Y. A data bus carries a computed 3Y partial product result from the dedicated arithmetic unit 45 into the partial product generator 30, and preferably into all other partial product generators, PP1-PP7 as well, of the digital multiplier 40 in accordance with a preferred embodiment of the invention depicted on FIG. 4.

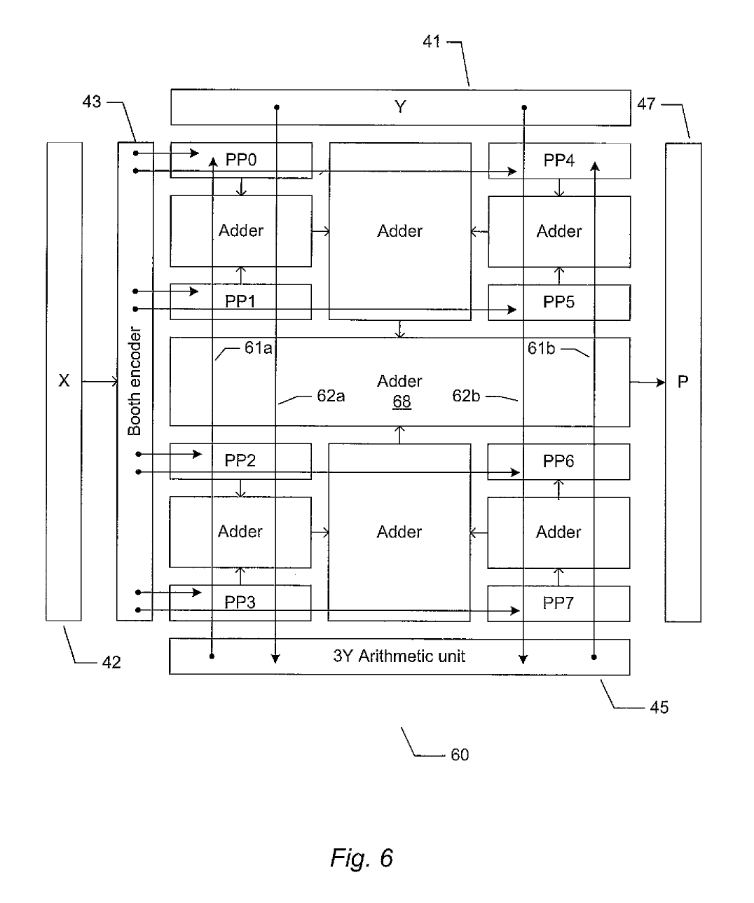

FIG. 4 is a schematic drawing of a 24×24 bit radix-8 Booth encoded digital multiplier 40 according to a first preferred embodiment of the present invention. A 24-bit multiplicand, Y, represented in two's complement format, is temporarily stored in a first register file 41 or other suitable memory structure and the multiplier, X, is held in a second register file 42 or other suitable memory structure. A Booth encoder 43 is operatively connected to the second register file 42 which holds a current value of X and uses successive sets of 4 bits for encoding respective sets of select signals to a set of eight partial products generators, PP0-PP7. The single Booth encoder 43 that operates on all eight partial products generators, PP0-PP7, implies that the digital multiplier 40 utilizes a substantially uniform or non-hybrid coding scheme for all partial product generators. The employed uniform or non-hybrid Booth coding scheme leads to a digital multiplier with a highly regular circuit layout on a semiconductor substrate or die, such as a sub-micron CMOS die. The highly regular circuit layout leads in turn to a very compact circuit layout which lowers costs of the digital multiplier circuit and reduces its power consumption since less die area and data bus routing is necessary. An exemplary highly regular circuit layout of the present digital multiplier 40 is illustrated in FIG. 6 and will be discussed in detail below in connection with that figure.

The eight partial product generators PP0-PP7 are of the same construction or design as the partial product generator 30 depicted on FIG. 3 above which means that they all lack arithmetic circuitry adapted to determine or compute the hard multiple, 3Y, which is three times the 24-bit multiplicand, Y. An arithmetic unit 45 is instead adapted to compute the hard multiple 3Y for each incoming set of Y (24-bit multiplicand) and X (24-bit multiplier) and transmit the computed value of 3Y into the partial product generators PP0-PP7 through the indicated data busses so that all eight partial product generators, PP0-PP7, share the current 3Y partial product result. Inside each partial product generator, the Booth encoder 43 determines a currently selected partial product result based on the value of the appropriate 4 bit set of the current value of X. A content and operation of the arithmetic unit 45 is described in more detail below. Respective outputs of the eight partial product generators, PP0-PP7, are summed in an adder structure or reduction tree 46 comprising a plurality of full adders and/or carry-propagate adders organized in a conventional adder structure such as a Wallace tree or a Dadda tree. An output of the adder tree 46 represents the multiplication result, P, which during operation of the digital multiplier is temporarily stored in a third register file 47 or other suitable memory structure.

While the present embodiment of the invention uses a single arithmetic unit 45 to compute 3Y for all the partial product generators PP0-PP7, other embodiments of the invention, may use two or even more arithmetic units and distribute two or more parallelly computed 3Y partial product results to separate groups of partial product generators. This may be advantageous in very large digital multiplier structures where shorter and/or simplified data bus routing across the digital multiplier can be exchanged for additional computational efforts and die area usage associated with the use of several arithmetic units. Other hard multiples than 3Y, such as 5Y or, 6Y or 7Y may instead or in addition be calculated by one, two or even more arithmetic units.

FIG. 5 shows the arithmetic unit 45 of FIG. 4 with a higher level of detail inside dotted box 45 and the residual portion of the digital multiplier of FIG. 4 in a generalized or conceptual manner. In this schematic drawing, the content of arithmetic unit 45 and the first register file 41 storing the multiplicand, Y, are integrated. The arithmetic unit 45 comprises a 24+24 bit full adder, indicated as, Adder, adapted to perform addition of 24 bit binary numbers Y and 2Y applied to its input terminals to generate the desired 3Y hard multiple partial product result. A 3Y latch functions as a temporary storage means for the 3Y partial product result and a parallel Y latch functions as a temporary storage means for Y. The 3Y latch and the Y latch are controlled by an appropriate clock signal or phase of the digital multiplier so that the 3Y partial product result is transmitted to the partial product generators in an appropriate phase of a multiplication cycle of the digital multiplier. The respective clock signals or phases applied to the arithmetic unit 45 and the partial product generators are configured so that the 3Y partial product result and partial products, PP0-PP(N-1) are computed sequentially in respective clock phases of a multiplication cycle. This sequential order reduces power consumption of the partial product generators, PP0-PP(N-1), and of the adder tree 46 as well, by avoiding to inject several waves of invalid or intermediate partial product calculations caused by unstable values of Y and 3Y.

In a second phase of the multiplication cycle, an adder tree structure 46 compresses or reduces the plurality of partial products generated by respective partial product generators PP0-PP(N-1). In a third phase of the multiplication cycle, the multiplication result, P, is transmitted to and temporarily stored in the third register file 47.

FIG. 6 is an exemplary circuit layout or floor-plan 60 of the 24*24 bit radix-8 Booth encoded digital multiplier depicted on FIGS. 4 & 5. The floor plan is essentially rectangular and symmetrical around a central vertical axis and central horizontal axis projecting centrally trough a centrally arranged final adder structure 68. Since none of partial product generators PP0-PP7 comprises arithmetic circuitry for local computation or determination of the 3Y partial product result they have extremely compact layouts. The arithmetic unit 45 is placed in a lower portion of the floor-plan 65 and receives the 24-bit multiplicand value, Y, by Y data busses 62a,b which extend vertically across the floor-plan 60 and conveys Y to respective sets of the partial product generators PP0-PP7.

First and second 3Y data busses 61a,b carries the 3Y partial product result computed by the arithmetic unit 45 into to respective sets of the partial product generators PP0-PP7.

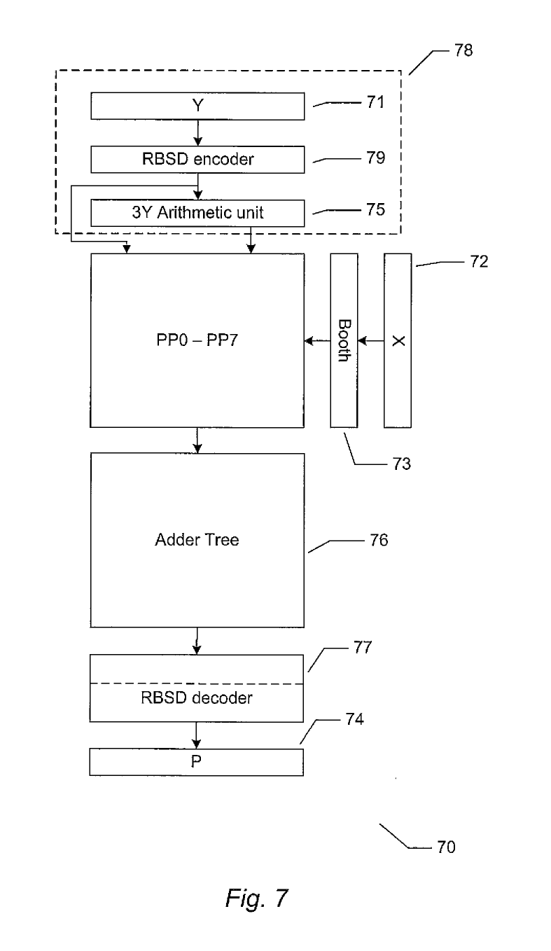

FIG. 7 is a schematic diagram of a 24*24-bit radix-8 Booth encoded digital multiplier 70 where the partial product generators are operating on binary numbers in redundant binary signed digit (RBSD) format according to a second preferred embodiment of the invention.

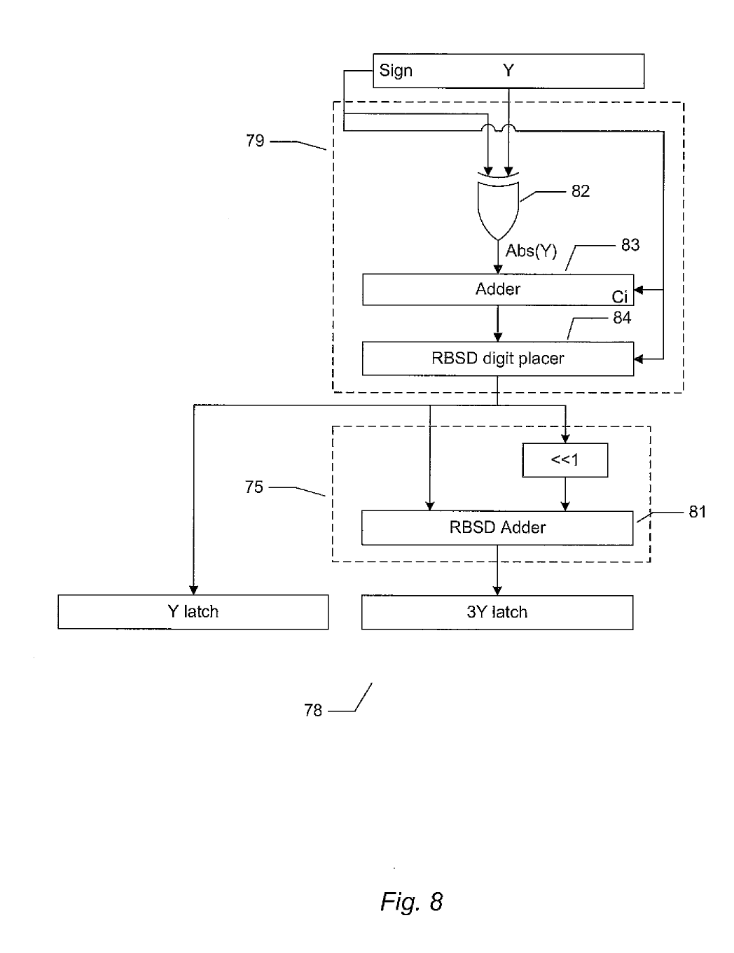

The digital multiplier 70 comprises an arithmetic unit 78 which comprises a first register file 71 holding a current value of a 24-bit multiplicand, Y, and operatively connected to a RBSD number format conversion unit 79 or RBSD conversion unit such that a current value of Y, which preferably is represented in two's complement format, is converted to a redundant binary signed digit format at an output of the RBSD conversion unit 79. Internal operation and circuitry of the RBSD conversion unit 79 is described below in detail in connection with FIG. 8. The RBSD conversion unit 79 has two outputs where a first output is operatively connected to a 3Y arithmetic unit 75 and a second output is operatively connected to a partial product generator array comprising plurality of partial product generators as illustrated by rectangular box PP0-PP7. The two outputs of the arithmetic unit 78 accordingly comprise a current value of Y and a current value of hard multiple 3Y which are both represented in the RBSD format. The 3Y partial product result is preferably transmitted to all the partial product generators PP0-PP7 so these are adapted to share the same 3Y partial product result in a manner which is similar to the one employed in the digital multiplier 40 (refer to FIG. 4) according to the first embodiment of the invention.

A current value of a 24-bit multiplier, X, represented in two's complement format, is temporarily stored in a second register file 72 or other suitable memory structure. X is preferably retained in a two's complement number format so that the operation of the Booth encoder 73 and its interaction with the plurality of partial product generators PP0-PP7 in the present embodiment of the invention is essentially similar to the operation of the Booth encoder 43 described above in connection with FIGS. 4 & 5. Respective outputs of the plurality of partial product generators PP0-PP7 are combined in an adder tree or structure 76 that comprises a plurality of redundant binary adder cells (RBAs), preferably configured as 3:2 compressors. An integrated adder and RBSD conversion unit 77 is adapted to perform two different tasks. A first task comprises combining outputs of the adder tree 76 to form a single intermediate multiplication result in RBSD format and a second task includes converting this intermediate multiplication result into a two's complement format to produce a final multiplication result, P, of the digital multiplier 70 in the latter format. A current value of P is stored in register file 74 for reading and further processing in digital circuits interfacing to the digital multiplier 70. While the described number format conversions forth and back between two's complement format and RBSD format may seem to impose additional hardware and computational effort compared to the digital multiplier 40 depicted on FIGS. 4, 5 & 6, a significant advantage lies in a simple and elegant method of generating many hard multiples of Y for RBSD formatted binary numbers, once 3Y has been computed inside the 3Y arithmetic unit 75. The simple method of computing many hard multiples of Y offsets any additional hardware expenditure that may be required for many embodiments of the invention, in particular for digital multipliers that apply very high radix figures such as radix-16, radix-32, radix-64 and more.

FIG. 8 is a detailed schematic diagram of the arithmetic unit 78 depicted in FIG. 7. A RBSD encoder 79 is adapted to generate an absolute value of Y by inputting Y and a sign bit of Y on XOR gate 82 and adding its output to the sign bit of Y. A RBSD digit placer 84 re-distributes the bits in a binary number on the output of the adder 83 to appropriate bit positions in accordance with the well-known format of RBSD numbers. The 3Y arithmetic unit 75 comprise a RBSD adder 81 adapted to compute and output the 3Y partial product result based on 3Y and Y provided on inputs of the RBSD adder 81.

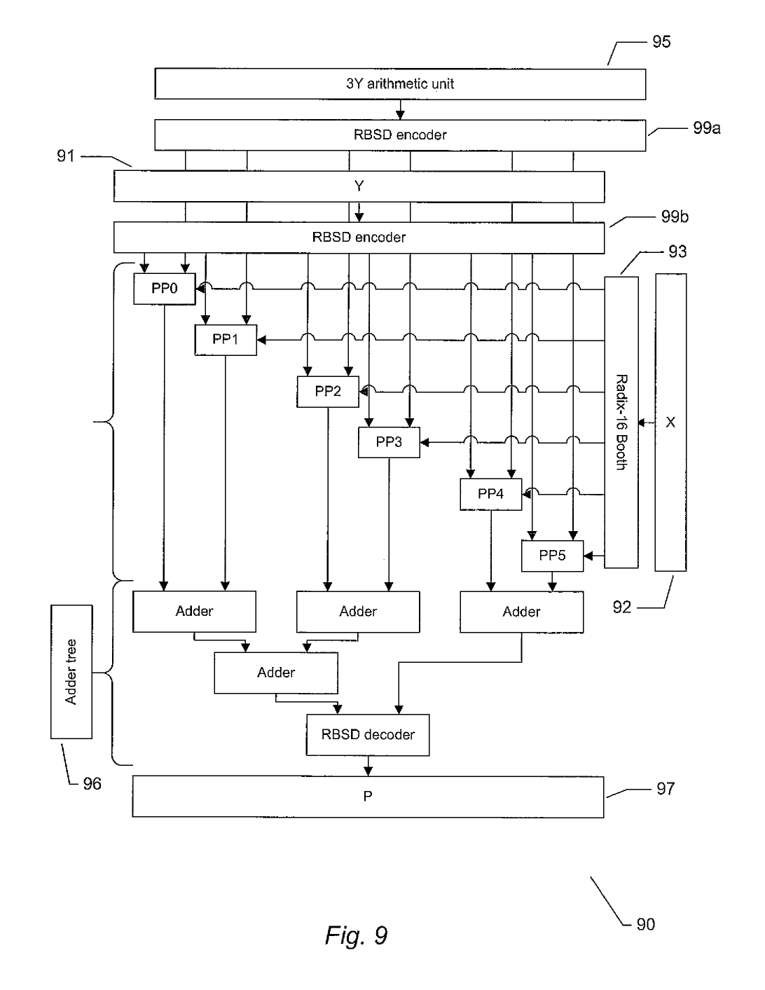

FIG. 9 shows a 24*24 bit radix-16 Booth encoded digital multiplier 90 adapted to operate on binary numbers represented in the redundant binary signed-digit format according to a third embodiment of the present invention. The radix-16 Booth encoding means that the number of partial product generators PP0-PP5 has been reduced to six compared to eight for the corresponding radix-8 digital multiplier depicted on FIGS. 4 & 5. The advantages of the RBSD format conversion as described in connection with the second embodiment of the invention, becomes particularly pronounced for radix-16 and higher digital multiplier architectures. The content of each of the partial product generators is described in detail below.

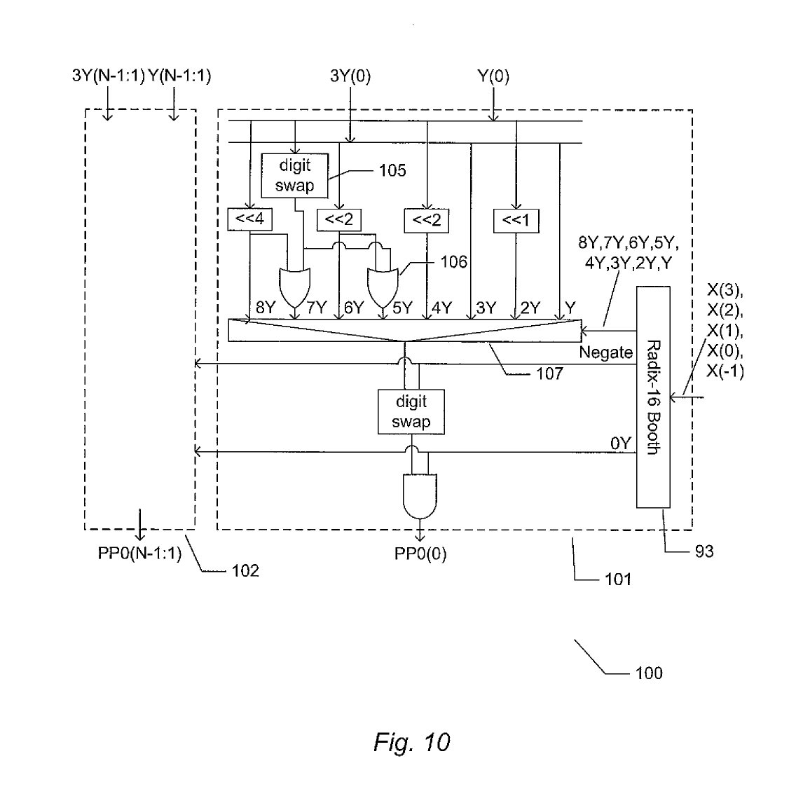

FIG. 10 is a schematic drawing of a partial product generator 100 based on radix-16 Booth encoding and adapted to operate on binary numbers represented in the redundant binary signed-digit format. The present partial product generator 100 is suitable for use in the digital multiplier 90 depicted in FIG. 9. A multiplexer 107 controlled by indicated select signals of Booth encoder 93 determines which one of the partial product result bits, Y(0), 2Y(0), 3Y(0), 4Y(0), 5Y(0), 6Y(0), 7Y(0) and 8Y(0) that is selected. Residual bits of 3Y, such as 3Y(1), 3Y(2), . . . 3Y(N-1), are also transmitted into all other respective partial product bit computation circuits 102 inside the indicated dashed box. The partial product result 3Y is accordingly computed by logic circuitry arranged entirely outside of the partial product generator 100.

Radix-16 Booth coding requires computation of the following partial product results: 8Y, 7Y, 6Y, 5Y, 4Y, 3Y, 2Y, Y, 0 and negative counterparts. However, since subtraction of two binary numbers can be performed at very low computational effort and circuitry in the RBSD format by an OR function or operation, it is possible to generate these partial product results by computing just a single one of the hard multiples such 5Y and/or 7Y, but preferably at least 3Y as indicated on the drawing. If only 3Y is computed, residual hard multiples of the above-mentioned set of partial product results can subsequently be computed with low computational effort by exploiting already available values of Y and 3Y in the following way:

7Y=8Y−Y;

6Y=2*3Y;

5Y=(2*3Y−Y).

3Y=3Y;

Digit swap unit 105 is adapted to exchange a bit order in Y(0), which is coded in RBSD format, and forward a bit-swapped result to OR gate 106 which in turn generates 5Y in an advantageous manner by performing an OR operation on the bit-swapped result and 6Y as indicated. Likewise, 7Y is generated by applying an OR operation on the bit swapped version of Y(0) and 8Y. Consequently, all hard multiples needed for performing the radix-16 Booth encoding are derived in a computationally efficient manner from a central computation of 3Y in the arithmetic unit 95 (refer to FIG. 9) with 3Y being transmitted into the partial product generator 100, and preferably also into all other partial product generators PP1-PP5 of the digital multiplier 90.

1. A digital multiplier configured to multiply an N-bit multiplicand with an M-bit multiplier, the digital multiplier comprising:
a first number format converter configured to receive the N-bit multiplicand in a first binary number format and convert the N-bit multiplicand into a second binary number format;
a plurality of partial product generators adapted to select respective partial products of the N-bit multiplicand, where each partial product is selected from a set of partial product results computed from the N-bit multiplicand in the second binary number format in dependence of a predetermined set of bits of the M-bit multiplier in accordance with a predetermined coding scheme;
an adder structure configured to receive and combine a plurality of partial products to produce an intermediate multiplication result; and
a second number format converter arranged to receive the intermediate multiplication result and convert the intermediate multiplication result into a P-bit multiplication result in the first binary number format;
wherein two or more partial product generators are adapted to share at least one partial product result, and each of P, M and N represent a positive integer number.

2. The digital multiplier according to claim 1, wherein substantially all partial product generators of the plurality of partial product generators utilize a non-hybrid or uniform predetermined coding scheme.

3. The digital multiplier according to claim 2, wherein more than 60%, more than 70%, or more than 90% of the partial product generators utilize the non-hybrid or uniform predetermined coding scheme.

4. The digital multiplier according to claim 1, wherein more than 60%, more than 70%, or more than 90% of the plurality of partial product generators are configured to share the at least one partial product result.

5. The digital multiplier according to claim 4, wherein all of the plurality of partial product generators are adapted to share the at least one partial product result.

6. The digital multiplier according to claim 1, wherein the at least one partial product result and all partial products are computed sequentially.

7. The digital multiplier according to claim 1, wherein:
N is smaller than 31, and/or
M is smaller than 31.

8. The digital multiplier according to claim 1, wherein the at least one partial product result comprises one or more hard multiples of the N-bit multiplicand in the second binary number format.

9. The digital multiplier according to claim 8, wherein the hard multiple comprises one or more partial product result(s) selected from a group of: {3 times N-bit multiplicand, 5 times N-bit multiplicand, 7 times N-bit multiplicand}.

10. The digital multiplier according to claim 8, comprising an arithmetic unit adapted to calculate the least one partial product result.

11. The digital multiplier according to claim 10, wherein the arithmetic unit comprises an adder and a shifter.

12. The digital multiplier according to claim 10, wherein the arithmetic unit is arranged outside the plurality of partial product generators, and the least one partial product result being transmitted into the two or more partial product generators is adapted to share at least one partial product result.

13. The digital multiplier according to claim 1, wherein the predetermined coding scheme comprises a Booth coding scheme selected from a group of {radix-16, radix-32, radix-64, radix-128} Booth coding.

14. The digital multiplier according to claim 1, wherein the first binary number format is selected from a group of {two's complement, signed magnitude, carry save}.

15. The digital multiplier according to claim 1, wherein the predetermined coding scheme comprises Booth coding.

16. The digital multiplier according to claim 1, wherein the second binary number format is redundant binary signed digit (RBSD).

17. (canceled)

18. A digital multiplier for multiplying binary numbers, comprising:
a first memory element for storing a N-bit multiplicand;
a second memory element for storing a M-bit multiplier;
a plurality of partial product generators adapted to select respective partial products of the N-bit multiplicand, where each partial product is selected from a set of partial product results computed from the N-bit multiplicand in dependence of a predetermined set of bits of the M-bit multiplier in accordance with a predetermined coding scheme;
an adder structure configured to receive and combine a plurality of partial products to produce a P-bit multiplication result; and
two or more partial product generators adapted to share at least one partial product result which comprises a hard multiple of the N-bit multiplicand;
wherein the plurality of partial product generators utilizes a uniform predetermined coding scheme;
each of P, M and N being a positive integer number.

19. The digital multiplier according to claim 18, wherein the predetermined coding scheme comprises a Booth coding scheme selected from a group of {radix-16, radix-32, radix-64, radix-128} Booth coding.

20. A semiconductor substrate comprising:
a digital multiplier integrated on the semiconductor substrate, said digital multiplier configured to multiply an N-bit multiplicand with an M-bit multiplier, the digital multiplier comprising:
a first number format converter configured to receive the N-bit multiplicand in a first binary number format and convert the N-bit multiplicand into a second binary number format;
a plurality of partial product generators adapted to select respective partial products of the N-bit multiplicand, where each partial product is selected from a set of partial product results computed from the N-bit multiplicand in the second binary number format in dependence of a predetermined set of bits of the M-bit multiplier in accordance with a predetermined coding scheme;
an adder structure configured to receive and combine a plurality of partial products to produce an intermediate multiplication result; and
a second number format converter arranged to receive the intermediate multiplication result and convert the intermediate multiplication result into a P-bit multiplication result in the first binary number format;
wherein two or more partial product generators are adapted to share at least one partial product result, and each of P, M and N represent a positive integer number;
wherein the digital multiplier has a substantially rectangular layout enclosed behind a circumferential border on a surface of the semiconductor substrate, the plurality of partial product generators is arranged in a partial product array close to the circumferential border, and the arithmetic unit is arranged adjacent to the circumferential border outside the partial product array; and
data busses extending across the partial product array and conveying the at least one shared partial product result into the two or more partial product generators.
